(19) United States
(12) Patent Application Publication
(10) Pub. No.: US 2025/0382463 A1
(43) Pub. Date: Dec. 18, 2025

(54) SHINGLE COATING COMPOSITION INCLUDING BIOSOURCED SOFTENERS

(71) Applicant: Owens Corning Intellectual Capital, LLC, Toledo, OH (US)

(72) Inventors: Ozma Norma Redd Pierce Lane, Columbus, OH (US); Shane Chris-Charles Gillies, Forest Park, IL (US); Massing Lewis Gleeson, Chicago, IL (US); Adam Lane, Lisle, IL (US); Jason Guerra, Tinley Park, IL (US); Sara Akbarian-Tefaghi, New Albany, OH (US)

(21) Appl. No.: 19/234,696

(22) Filed: Jun. 11, 2025

Related U.S. Application Data
(60) Provisional application No. 63/660,040, filed on Jun. 14, 2024.

(51) Int. Cl. C08L 95/00; C09D 7/63; C09D 195/00; E04D 1/20; E04D 12/00

(52) U.S. Cl. CPC C08L 95/00; C09D 7/63; C09D 195/00; E04D 1/20; E04D 12/002; C08L 2205/025; C08L 2205/035; C08L 2205/08; C08L 2207/22; C08L 2555/64

(57) ABSTRACT

Various aspects described herein are directed to an asphalt composition comprising about 10 wt. % to about 80 wt. % of a base asphalt, about 1 wt. % to about 40 wt. % of a hardener having an acid value of less than 30 meq KOH, about 1 wt. % to about 20 wt. % of a phenolic lipid-based compatibilizer, and 0 to about 10 wt. % of a wax. The asphalt composition has a penetration value according at 25° C. of no less than 15 dmm and a softening point of at least 93° C. Aspects are also directed to methods of modifying the hardness of an asphalt composition and roofing materials including the asphalt compositions.

### CROSS-REFERENCE TO RELATED APPLICATIONS

This application claims priority to and all benefit of U.S. Provisional Patent Application No. 63/660,040, filed on Jun. 14, 2024, the entire disclosure of which is fully incorporated herein by reference.

### BACKGROUND

Asphalt-based roofing materials, such as roofing shingles, roll roofing and commercial roofing, are installed on roofs of buildings to provide protection from the elements, and to provide a pleasing aesthetic appearance. Roofing materials are often constructed of a substrate such as a glass fiber mat or an organic felt, an asphalt coating on the substrate, and, optionally, a surface layer of granules embedded in the asphalt coating.

Conventional asphalt coating compositions, including oxidized or polymer modified asphalt compositions, require application at a high temperature (e.g., from 176° C. to 205° C.), which contributes to higher carbon emissions and water consumption. The use of these high temperatures during manufacturing may also be expensive and present a safety concern. Accordingly, there is a continuing need for alternative asphalt-based coating compositions for use in roofing applications.

### BRIEF SUMMARY

Various aspects described herein are directed to an asphalt composition comprising about 10 wt. % to about 80 wt. % of a base asphalt, about 1 wt. % to about 40 wt. % of a hardener having an acid value of less than 30 meq KOH, about 1 wt. % to about 20 wt. % of a phenolic lipid-based compatibilizer, and 0% to about 10 wt. % of a wax. The asphalt composition has a penetration value at 25° C. of no less than 15 dmm and a softening point of at least 93° C. (199° F.).

In any of the aspects, the phenolic lipid-based compatibilizer is free of carboxyl groups, carbonyl groups, and derivatives thereof. In aspects, the phenolic lipid-based compatibilizer comprises a phenolic liquid. The phenolic lipid-based compatibilizer may comprise a cashew nut shell liquid, cashew nut shell distillate, cardol, cardanol, or mixtures thereof.

In aspects, the base asphalt comprises paving grade asphalt, oxidized asphalt, non-oxidized asphalt, polymer-modified asphalt, or mixtures thereof. In any of the aspects, the base asphalt may be a polymer modified asphalt and the asphalt composition further comprises up to 15 wt. % of a polymer additive comprising one or more of reclaimed rubber, natural rubber, ground tire rubber (GTR), devulcanized ground tire rubber, styrene-butadiene block copolymer (SBS), chloroprene rubber (CR), amorphous polyolefin, latex, butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated SBS, vinylacetate/polyethylene (EVA), and mixtures thereof.

According to aspects disclosed herein, the hardener may be selected from the group consisting of a modified pine resin, a modified pine rosin, a tall pitch oil, and mixtures thereof. In any of the aspects disclosed herein, the asphalt composition may be a coating on a roofing material.

Various aspects disclosed herein are directed to an asphalt composition comprising about 10 wt. % to about 60 wt. % of a base asphalt, 20 wt. % to about 70 wt. % of recycled or reclaimed asphalt material having a penetration value at 25° C. of from 0 dmm to 10 dmm, about 1 wt. % to about 40 wt. % of a hardener having an acid value of less than 30 meq KOH, about 1 wt. % to about 15 wt. % of a phenolic lipid-based compatibilizer, and 0 to about 10 wt. % of a wax, wherein the asphalt composition has a viscosity at 204° C. of less than 400 cP.

In any of the aspects disclosed herein, the reclaimed asphalt material may comprise greater than 50% asphalt content. In aspects, the reclaimed asphalt material comprises greater than 75% asphalt content.

Various aspects disclosed herein are directed to a method of modifying the hardness of an asphalt coating composition, the method comprising forming an asphalt composition having a first penetration value and introducing about 1 wt. % to about 40 wt. % of a hardener into the asphalt composition to achieve a second penetration value. The second penetration value is less than the first penetration value. The asphalt composition having the first penetration value is formed by blending about 10 wt. % to about 80 wt. % of a base asphalt, about 1 wt. % to about 20 wt. % of a phenolic lipid-based compatibilizer, and 0 to about 10 wt. % of a wax.

Additionally, various aspects are directed to a roofing material comprising a substrate and an asphalt coating applied to at least a portion of the substrate. The asphalt coating comprises about 10 wt. % to about 80 wt. % of a base asphalt, about 1 wt. % to about 40 wt. % of a hardener having an acid value of less than 30 meq KOH, about 1 wt. % to about 20 wt. % of a phenolic lipid-based compatibilizer, and 0 to about 10 wt. % of a wax.

### BRIEF DESCRIPTION OF THE DRAWING

The general inventive concepts, as well as embodiments and advantages thereof, are described in greater detail, by way of example, with reference to the drawing in which:

FIG. 1 graphically illustrates the log 10 of the complex modulus (in MPa; y-axis) as a function of phase angle (in degrees; x-axis).

### DETAILED DESCRIPTION

Several illustrative aspects will be described in detail with the understanding that the present disclosure merely exemplifies the general inventive concepts. Aspects encompassing the general inventive concepts may take various forms and the general inventive concepts are not intended to be limited to the specific aspects described herein.

Disclosed herein are asphalt compositions that include a synergistic combination of a hardener and a phenolic lipid-based compatibilizer that can be tuned to provide roofing coating specifications of softening point and penetration, while having a lower viscosity, which enables application at temperatures between about 120° C. and 176° C. The asphalt compositions disclosed herein include a base asphalt, a hardener, a phenolic lipid-based compatibilizer, and a wax.

The terminology as set forth herein is for description only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent the term “includes” or “including” is used in the description or the claims, it is intended to be inclusive in a manner similar to the term “comprising” as that term is interpreted when employed as a transitional word in a claim. Furthermore, to the extent the term “or” is employed (e.g., A or B), it is intended to mean “A or B or both.” When the applicants intend to indicate “only A or B but not both,” then the term “only A or B but not both” will be employed. Thus, use of the term “or” herein is the inclusive, and not the exclusive use.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The methods of the present disclosure can comprise, consist of, or consist essentially of the essential elements of the disclosure as described herein, as well as any additional or optional element described herein, or which is otherwise useful in roofing applications.

### Asphalt Compositions

The asphalt composition comprises an asphalt base material, or base asphalt, which is understood to mean any asphalt base material composed of one or more asphalt bases and optionally comprising one or more additives. As used herein, the term “asphalt” is meant to include any bituminous materials produced from petroleum refining, including residua from atmospheric distillation, from vacuum distillation, from solvent de-asphalting units, and from recycled asphalt streams, such as re-refined motor oil bottoms and extracted asphalt from recycled asphalt shingles. Mixtures of different asphalts can also be used. Some aspects disclosed herein can also be used with natural bitumen, such as the products extracted from oil sands in Alberta or asphalts derived from oil sands by various refinery processes. Unless otherwise clearly denoted herein, the asphalt composition is unfilled, and all weight percent values are indicated on an unfilled asphalt basis. Asphalt compositions further comprising fillers are detailed elsewhere in this disclosure.

The base asphalt may be visbroken and/or deasphalted (i.e., propane deasphalted asphalt) and/or partially or fully oxidized. In some aspects, the base asphalt may be prepared using a wide array of paving grade asphalt materials, such as different types of paving asphalts used independently or as a mixture with various types of asphalt, such as, for example, solvent extracted asphalt, naturally occurring asphalt, synthetic asphalt, and recycled asphalt. The various asphalt bases can be combined with one another in order to obtain the best technical compromise.

The base asphalt may comprise one or more of flux, paving grade asphalt or paving grade asphalt blends, propane deasphalted asphalt, partially or fully oxidized asphalt, non-oxidized asphalt, polymer-modified asphalt and/or blends thereof. By “paving grade asphalt,” as used herein, is meant a performance grade asphalt according to AASHT20 17320-17 that has a softening point within the range of about 60° F. to about 130° F. and a penetration value of at least about 25 decimillimeter (dmm). Paving grade asphalts are not typically used in roofing applications because such asphalts are not able to achieve the properties required to be considered “coating grade” asphalt, as defined by ASTM D 3462-16: a softening point minimum of from 190° F. (88° C.) to 235° F. (113° C.) and a penetration at 77° F. (25° C.) and a minimum of 15 dmm.

The asphalt material in the asphalt composition may include at least one type of paving-grade asphalt. Any suitable paving-grade asphalt(s) can be used, for example paving asphalts meeting the PG 64-22 specifications (AASHTO M320 or AASHTO M332). PG 64-22 is the most common paving specification in the United States. Historically, paving asphalts were graded by viscosity, and a comparable asphalt to PG 64-22 that can also be used is the old AC20 grade asphalt (ASTM D 3381). Other examples of suitable paving-grade asphalts include PG 67-22, PG 70-22, PG 58-22, PG 58-28, PG 58-22, PG 70-16, PG 70-10, PG 67-10, pen grade 40/50, pen grade 60/70, pen grade 85/100, pen grade 120/150, AR4000, AR8000, and AC/30 grade.

The base asphalt may be included in the asphalt composition in an amount of from about 10 wt. % to about 80 wt. %, based on the weight of the asphalt composition. For example, the asphalt composition may include from about 10 wt. % to about 80 wt. %, from about 20 wt. % to about 80 wt. %, from about 30 wt. % to about 80 wt. %, from about 40 wt. % to about 80 wt. %, from about 50 wt. % to about 80 wt. %, from about 60 wt. % to about 80 wt. %, from about 10 wt. % to about 70 wt. %, from about 20 wt. % to about 70 wt. %, from about 30 wt. % to about 70 wt. %, from about 40 wt. % to about 70 wt. %, from about 50 wt. % to about 70 wt. %, from about 60 wt. % to about 70 wt. %, from about 10 wt. % to about 60 wt. %, from about 20 wt. % to about 60 wt. %, from about 30 wt. % to about 60 wt. %, from about 40 wt. % to about 60 wt. %, from about 50 wt. % to about 60 wt. %, from about 10 wt. % to about 50 wt. %, from about 20 wt. % to about 50 wt. %, from about 30 wt. % to about 50 wt. %, or from about 40 wt. % to about 50 wt. %, of the base asphalt, including all endpoints and subranges therebetween, based on the total weight of the asphalt composition.

The asphalt base material may optionally further comprise at least one polymer additive. The polymer additive may comprise an elastomeric radial or linear polymer. The polymer additive may comprise a copolymer such as a linear or radial copolymer. In some embodiments the polymer additive comprises one or more of atactic polypropylene (APP), isotactic polypropylene (IPP), styrene-butadiene-styrene rubber (SBS), polychloroprene; polynorbornene; chloroprene rubber (CR), natural and reclaimed rubbers (including ground tire rubber (GTR) and devulcanized ground tire rubber), butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated SBS, vinylacetate/polyethylene (EVA), ethylene-methylacrylate copolymers (EMA), copolymers of olefins and unsaturated carboxylic esters such as ethylene-butylacrylates (EBA), polyolefinic copolymers, polyolefins such as polybutenes (PB), copolymers of ethylene and esters of acrylic acid or methacrylic acid or maleic anhydride, copolymers and terpolymers of ethylene and glycidyl methacrylate, ethylene/propylene copolymers, rubber, and mixtures thereof. In other exemplary embodiments, the polymer additive comprises a linear polymer or a combination of linear and radial polymers. Examples of polymer modifiers are also disclosed in U.S. Pat. No. 4,738,884 to Algrim et al., U.S. Pat. No. 3,770,559 to Jackson, and 11,028,591 to LaTorre et al., the contents of which are incorporated herein by reference in their entirety. In some exemplary embodiments, the asphalt is modified with styrene-butadiene-styrene rubber (SBS).

The polymer additive may be included in the asphalt base material in an amount from about 0.5 wt. % to about 15.0 wt. %, based on the weight of the asphalt composition. The polymer additive may be included in an amount from about 1.0 to about 15.0 wt. %, or from about 1.5 to about 10.0 wt. %, or from about 2.0 to about 7.0 wt. %, or from about 3.0 to about 6.5 wt. %, or about 5.0 to about 6.0 wt. %, based on the weight of the asphalt composition.

As mentioned above, current asphalt roofing products require the use of high temperatures (e.g., 176° C.-190° C.) to apply oxidized or polymer modified asphalt. It has been surprisingly discovered that the synergistic inclusion of a hardener and a phenolic lipid-based compatibilizer, as described herein, provides tunable asphalt coating formulations that can allow roofing-grade penetration values without compromising softening point. Additionally, the resulting asphalt coating formulations can have a lower viscosity (as compared to asphalt coating formulations without the hardener and phenolic lipid-based compatibilizer), which may in turn allow applications at lower temperatures (i.e., about 120° C. to about 176° C.), leading to a safer and less expensive product. Accordingly, the asphalt compositions described herein include a hardener having an acid value of less than about 30 mEq KOH. The hardener may be effective to decrease the penetration value of the asphalt composition as compared to the penetration value of the base asphalt composition without the hardener. Such hardeners can include, for example, a modified pine resin, modified pine rosin, tall pitch oil, and mixtures thereof. The modified pine resin and/or modified pine rosin may be maleated or fumarated, for example. Other modifications to the pine resin or pine rosin are possible and contemplated, provided that the modified pine resin or rosin is effective to modify the softening point of the asphalt composition.

In aspects, the hardener may have an acid value of from 0 mEq KOH to about 30 mEq KOH, from about 5 mEq KOH to about 30 mEq KOH, from about 10 mEq KOH to about 30 mEq KOH, from about 15 mEq KOH to about 30 mEq KOH, from about 20 mEq KOH to about 30 mEq KOH, from about 25 mEq KOH to about 30 mEq KOH, from 0 mEq KOH to about 25 mEq KOH, from about 5 mEq KOH to about 25 mEq KOH, from about 10 mEq KOH to about 25 mEq KOH, from about 15 mEq KOH to about 25 mEq KOH, from about 20 mEq KOH to about 25 mEq KOH, from 0 mEq KOH to about 20 mEq KOH, from about 5 mEq KOH to about 20 mEq KOH, from about 10 mEq KOH to about 20 mEq KOH, from about 15 mEq KOH to about 20 mEq KOH, from 0 mEq KOH to about 15 mEq KOH, from about 5 mEq KOH to about 15 mEq KOH, or from about 10 mEq KOH to about 15 mEq KOH, including all endpoints and subranges therebetween.

The hardener can be included in the asphalt composition in an amount of from about 1 wt. % to about 40 wt. %, based on the weight of the asphalt composition. For example, the hardener may be included in the asphalt composition in an amount of from about 1 wt. % to about 40 wt. %, from about 2 wt. % to about 40 wt. %, from about 5 wt. % to about 40 wt. %, from about 10 wt. % to about 40 wt. %, from about 15 wt. % to about 40 wt. %, from about 20 wt. % to about 40 wt. %, from about 25 wt. % to about 40 wt. %, from about 30 wt. % to about 40 wt. %, from about 1 wt. % to about 30 wt. %, from about 2 wt. % to about 30 wt. %, from about 5 wt. % to about 30 wt. %, from about 10 wt. % to about 30 wt. %, from about 15 wt. % to about 30 wt. %, from about 20 wt. % to about 30 wt. %, from about 25 wt. % to about 30 wt. %, from about 1 wt. % to about 25 wt. %, from about 2 wt. % to about 25 wt. %, from about 5 wt. % to about 25 wt. %, from about 10 wt. % to about 25 wt. %, from about 15 wt. % to about 25 wt. %, from about 20 wt. % to about 25 wt. %, from about 1 wt. % to about 20 wt. %, from about 5 wt. % to about 20 wt. %, from about 10 wt. % to about 20 wt. %, from about 15 wt. % to about 20 wt. %, from about 1 wt. % to about 15 wt. %, from about 2 wt. % to about 15 wt. %, from about 5 wt. % to about 15 wt. %, from about 10 wt. % to about 15 wt. %, from about 1 wt. % to about 10 wt. %, from about 2 wt. % to about 10 wt. %, from about 5 wt. % to about 10 wt. %, from about 1 wt. % to about 7.5 wt. %, or from about 2 wt. % to about 7.5 wt. %, including all endpoints and subranges therebetween, based on the weight of the asphalt composition.

As introduced above, the asphalt composition includes a synergistic combination of a hardener and a phenolic lipid-based compatibilizer that can be tuned to provide roofing coating specifications of softening point and penetration, while having a lower viscosity (e.g., a rotational viscosity of less than about 400 cP when measured at 190° C.), which enables application at temperatures between about 120° C. and 176° C. Specifically, the phenolic lipid-based compatibilizer may help to lower the softening point, increase the penetration values, and decrease the viscosity of the asphalt composition as compared to an otherwise identical asphalt composition that does not include the phenolic lipid-based compatibilizer. The phenolic lipid-based compatibilizer may further act as a plasticizer to help reclaimed asphalt material (described below) dissolve in the asphalt composition.

In general, the phenolic lipid-based compatibilizer is derived from a bio-based source material. The term “bio-based” is intended to be used herein interchangeably with the term “plant-based,” i.e., to indicate materials that are not synthesized or otherwise derived from nonrenewable fossil fuel feedstocks such as coal or petroleum. More specifically, the phenolic lipid-based compatibilizer is extracted from a bio-based source material, and may comprise a liquid distillate extracted from the bio-based source material. Thus, the phenolic lipid-based compatibilizer may comprise a distillation residue obtained from the distillation or extraction from, for instance, cashew nut shell oil.

The phenolic lipid-based compatibilizer may comprise an aromatic group with one, or two, or more hydroxy groups and an aliphatic tail group. The compatibilizer may consist of a phenolic lipid. The phenolic lipid-based compatibilizer may be functionalized, i.e., functional groups may be added or otherwise modified to manipulate aspects of the compatibilizer's performance. For example, it may be desirable to modify the phenolic lipid-based compatibilizer so as to avoid crosslinking with other additives that may be present in the asphalt composition. The phenolic lipid-based compatibilizer may include modifications to the functional groups on any double bonds, or of the aromatic hydroxyl groups. Non-limiting examples of modifications include the addition of organic or inorganic functional groups, including, without limitation, alcohol groups, amine groups, amide groups, epoxy groups, esterified derivatives, and grafted oligomers. That said, the subject phenolic lipid-based compatibilizer excludes the modifications of added carboxyl groups, carbonyl groups, or combinations thereof.

The phenolic lipid-based compatibilizer may comprise, or consist of, cashew nut shell liquid, cashew nut shell distillate, Cardol, Cardanol, derivatives thereof, or mixtures thereof. Cashew nut shell distillate is distinct from cashew nut shell liquid (“CNSL”) i.e., CNSL constitutes an upstream source product from which the cashew nut shell distillate may be selectively extracted. The phenolic lipid-based compatibilizer may be free of (i.e., devoid of) carboxyl groups, carbonyl groups, or combinations thereof. The phenolic lipid-based compatibilizer may be free of sterols, stanols, or combinations thereof. The phenolic lipid-based compatibilizer may be free of anacardic acid.

In aspects, the phenolic lipid-based compatibilizer can be a dimer, trimer, or oligomer having a molecular weight of from about 250 g/mol to about 1,000 g/mol. For example, the phenolic lipid-based compatibilizer may have a molecular weight of from about 250 g/mol to about 1,000 g/mol, from about 275 g/mol to about 1,000 g/mol, from about 300 g/mol to about 1,000 g/mol, from about 250 g/mol to about 950 g/mol, from about 275 g/mol to about 950 g/mol, from about 300 g/mol to about 950 g/mol, from about 250 g/mol to about 900 g/mol, from about 275 g/mol to about 900 g/mol, from about 300 g/mol to about 900 g/mol, from about 250 g/mol to about 850 g/mol, from about 275 g/mol to about 850 g/mol, from about 300 g/mol to about 850 g/mol, from about 250 g/mol to about 800 g/mol, from about 275 g/mol to about 800 g/mol, from about 300 g/mol to about 800 g/mol, from about 250 g/mol to about 750 g/mol, from about 275 g/mol to about 750 g/mol, from about 300 g/mol to about 750 g/mol, from about 250 g/mol to about 700 g/mol, from about 275 g/mol to about 700 g/mol, or from about 300 g/mol to about 700 g/mol, including all endpoints and subranges therebetween. In some aspects, the phenolic lipid-based compatibilizer may be a monomer having a molecular weight of from about 300 g/mol to about 330 g/mol, a dimer having a molecular weight of from about 600 g/mol to about 700 g/mol, or a trimer having a molecular weight of from about 900 g/mol to about 1,000 g/mol.

The phenolic lipid-based compatibilizer may be included in the asphalt composition in an amount of from about 1 wt. % to about 20 wt. %, based on the weight of the asphalt composition. For example, the phenolic lipid-based compatibilizer may be included in the asphalt composition in an amount of from about 1 wt. % to about 20 wt. %, from about 2 wt. % to about 20 wt. %, from about 5 wt. % to about 20 wt. %, from about 7 wt. % to about 20 wt. %, from about 10 wt. % to about 20 wt. %, from about 12 wt. % to about 20 wt. %, from about 15 wt. % to about 20 wt. %, from about 1 wt. % to about 15 wt. %, from about 2 wt. % to about 15 wt. %, from about 5 wt. % to about 15 wt. %, from about 7 wt. % to about 15 wt. %, from about 10 wt. % to about 15 wt. %, from about 12 wt. % to about 15 wt. %, from about 1 wt. % to about 12 wt. %, from about 2 wt. % to about 12 wt. %, from about 5 wt. % to about 12 wt. %, from about 7 wt. % to about 12 wt. %, from about 10 wt. % to about 12 wt. %, from about 1 wt. % to about 7 wt. %, from about 2 wt. % to about 7 wt. %, from about 5 wt. % to about 7 wt. %, from about 1 wt. % to about 5 wt. %, or from about 2 wt. % to about 5 wt. %, including all endpoints and subranges therebetween, based on the weight of the asphalt composition.

The phenolic lipid-based compatibilizer is included in the asphalt composition such that a weight ratio of the phenolic lipid-based compatibilizer to hardener is from 1:20 to 1:1. For example, a weight ratio of the phenolic lipid-based compatibilizer to hardener may be 1:20 to 1:1, 1:17 to 1:1, 1:15 to 1:1, 1:12 to 1:1, 1:10 to 1:1, 1:8 to 1:1, 1:6 to 1:1, 1:4 to 1:1, 1:3 to 1:1, or 1:2 to 1:1, including all endpoints and subranges therebetween.

As set forth above, the asphalt composition further includes a wax to raise the softening point of the asphalt composition. Any type of wax, or a mixture of different waxes, capable of functioning as described herein can be used in the asphalt composition. For instance, the wax may comprise one or more of a paraffin wax and a non-paraffin wax. Paraffin waxes typically have melting points below 70° C. and have less than 45 carbon atoms. Non-paraffin waxes typically have melting points above 70° C. and have more than 45 carbon atoms. The non-paraffin wax can be one or more of a natural wax, a modified natural wax, a partial synthetic wax, and a full synthetic wax. Non-limiting examples of suitable partial and fully synthetic waxes include ethylene bis-stearamide wax (EBS), Fischer-Tropsch wax (e.g., SASOBIT™), stearic acid pitch, polyolefin waxes such as oligomerized or depolymerized polyolefins, polyethylene wax (PE), oxidized polyethylene wax (PEO), polypropylene wax, polyethylene terephthalate (PET) waxes, and polypropylene/polyethylene wax; alcohol wax, silicone wax, petroleum waxes such as microcyrstalline wax, chlorinated wax, acrylic waxes, oil amide waxes, and combinations thereof. Any suitable mixtures of different waxes can also be used. For example, the wax can include a blend of a Fischer-Tropsch wax and a polyethylene wax. The waxes may be recycled, reclaimed, or virgin waxes. For example, the wax may be a recycled, reclaimed, or virgin polyethylene or polypropylene wax. Other recycled waxes, such as recycled nylon and acrylic may be used in one or more aspects.

The wax may be included in the asphalt composition in an amount of from 0 wt. % to about 10 wt. %, based on the weight of the asphalt composition. For example, the wax may be included in the asphalt composition in an amount of from 0 wt. % to about 10 wt. %, from about 1 wt. % to about 10 wt. %, from about 2 wt. % to about 10 wt. %, from about 3 wt. % to about 10 wt. %, from about 4 wt. % to about 10 wt. %, from 0 wt. % to about 9 wt. %, from about 1 wt. % to about 9 wt. %, from about 2 wt. % to about 9 wt. %, from about 3 wt. % to about 9 wt. %, from about 4 wt. % to about 9 wt. %, from 0 wt. % to about 8 wt. %, from about 1 wt. % to about 8 wt. %, from about 2 wt. % to about 8 wt. %, from about 3 wt. % to about 8 wt. %, from about 4 wt. % to about 8 wt. %, from 0 wt. % to about 7 wt. %, from about 1 wt. % to about 7 wt. %, from about 2 wt. % to about 7 wt. %, from about 3 wt. % to about 7 wt. %, from about 4 wt. % to about 7 wt. %, from 0 wt. % to about 6 wt. %, from about 1 wt. % to about 6 wt. %, from about 2 wt. % to about 6 wt. %, from about 3 wt. % to about 6 wt. %, from about 4 wt. % to about 6 wt. %, from 0 wt. % to about 5 wt. %, from about 1 wt. % to about 5 wt. %, from about 2 wt. % to about 5 wt. %, from about 3 wt. % to about 5 wt. %, or from about 4 wt. % to about 5 wt. %, based on the weight of the asphalt composition, including all endpoints and subranges therebetween.

The asphalt composition may further include recycled or reclaimed asphalt material. The reclaimed asphalt material can include, for example, asphalt extracted from recycled asphalt shingles (“RAS”). In some aspects, the reclaimed asphalt material includes greater than about 50 wt. % asphalt content. For example, the reclaimed asphalt material may include greater than about 50 wt. %, greater than about 55 wt. %, greater than about 60 wt. %, greater than about 65 wt. %, greater than about 70 wt. %, greater than about 75 wt. %, or even greater than about 80 wt. % asphalt content, based on the total weight of the reclaimed asphalt material.

When included, the reclaimed asphalt material may be included in the asphalt composition in an amount of from about 0.5 wt. % to about 70 wt. %, based on weight of the asphalt composition. For example, the reclaimed asphalt material may be included in the asphalt composition in an amount from about 1 wt. % to less than about 70 wt. %, from about 2 wt. % to about 65 wt. %, from about 4 wt. % to about 62 wt. %, from about 5 wt. % to about 60 wt. %, from about 8 wt. % to about 55 wt. %, from about 10 wt. % to about 70 wt. %, from about 13 wt. % to about 68 wt. %, from about 15 wt. % to about 65 wt. %, from about 20 wt. % to about 62 wt. %, from about 20 wt. % to about 70 wt. %, from about 22 wt. % to about 68 wt. %, from about 25 wt. % to about 65 wt. %, from about 28 wt. % to about 63 wt. %, from about 30 wt. % to about 70 wt. %, from about 32 wt. % to about 68 wt. %, from about 35 wt. % to about 65 wt. %, from about 38 wt. % to about 62 wt. %, from about 40 wt. % to about 40 wt. %, from about 42 wt. % to about 68 wt. %, from about 45 wt. % to about 65 wt. %, or from about 1 wt. % to about 20 wt. %, based on the weight of the total solids content of the asphalt composition, including all endpoints and subranges therebetween. However, it should be understood that the inclusion of reclaimed asphalt material is optional and, accordingly, in aspects, the asphalt composition does not include reclaimed asphalt material. On the other hand, in some aspects, the base asphalt may comprise greater than 75 wt. %, such as greater than 85 wt. %, greater than 90 wt. % or 100 wt. % reclaimed asphalt, such that the asphalt composition includes little to no virgin asphalt material.

The reclaimed asphalt material may have a softening point of from 132° C. to 160° C., as measured according to the Ring and Ball Softening Point Test described in ASTM D36. For example, the reclaimed asphalt material may have a softening point of from 132° C. to 160° C., from 132° C. to 155° C., from 132° C. to 150° C., from 135° C. to 160° C., from 135° C. to 155° C., from 135° C. to 150° C., from 140° C. to 160° C., from 140° C. to 155° C., or from 140° C. to 150° C., including all endpoints and subranges therebetween.

The reclaimed asphalt material may have a viscosity of from 1,500 cP to 10,000 cP when measured at 204° C. and in accordance with ASTM D4402. For example, the reclaimed asphalt material may have a viscosity of from 1,500 cP to 10,000 cP, from 2,000 cP to 10,000 cP, from 3,000 cP to 10,000 cP, from 4,000 cP to 10,000 cP, from 5,000 cP to 10,000 cP, from 1,500 cP to 7,500 cP, from 2,000 cP to 7,500 cP, from 3,000 cP to 7,500 cP, from 4,000 cP to 7,500 cP, from 5,000 cP to 7,500 cP, from 1,500 cP to 5,000 cP, from 2,000 cP to 5,000 cP, from 3,000 cP to 5,000 cP, or from 4,000 cP to 5,000 cP, including all endpoints and subranges therebetween.

In various aspects, the reclaimed asphalt material may further have a penetration value at 25° C. of from about 0 dmm to about 8 dmm, or from about 0 dmm to about 7 dmm. Despite the inclusion of the reclaimed asphalt material having a relatively high penetration value, the synergistic blend of a hardener and a phenolic lipid-based compatibilizer in the asphalt composition enables the resultant asphalt composition to have a penetration value of no less than 15 dmm at 25° C., such as no less than 16 dmm, no less than 17 dmm, no less than 18 dmm, or no less than 20 dmm.

Accordingly, when included, the reclaimed asphalt material may be included in the asphalt composition in an amount such that a weight ratio of phenolic lipid-based compatibilizer to reclaimed asphalt material is from 1:99 to 1:4. For example, a weight ratio of phenolic lipid-based compatibilizer to reclaimed asphalt material may be from 1:99 to 1:4, from 1:99 to 1:6, from 1:99 to 1:10, from 1:99 to 1:15, from 1:99 to 1:20, from 1:99 to 1:25, from 1:99 to 1:30, from 1:99 to 1:35, from 1:99 to 1:40, from 1:99 to 1:50, from 1:95 to 1:4, from 1:95 to 1:6, from 1:95 to 1:10, from 1:95 to 1:15, from 1:95 to 1:20, from 1:95 to 1:25, from 1:95 to 1:30, from 1:95 to 1:35, from 1:95 to 1:40, from 1:95 to 1:50, from 1:90 to 1:4, from 1:90 to 1:6, from 1:90 to 1:10, from 1:90 to 1:15, from 1:90 to 1:20, from 1:90 to 1:25, from 1:90 to 1:30, from 1:90 to 1:35, from 1:90 to 1:40, from 1:90 to 1:50, from 1:80 to 1:4, from 1:80 to 1:6, from 1:80 to 1:10, from 1:80 to 1:15, from 1:80 to 1:20, from 1:80 to 1:25, from 1:80 to 1:30, from 1:80 to 1:35, from 1:80 to 1:40, or from 1:80 to 1:50, including all endpoints and subranges therebetween.

A filled asphalt composition can include the asphalt composition of various aspects with a filler material. The filler material may be included in an amount of from greater than 0 wt. % to about 70 wt. %, based on the total weight of the filled asphalt composition. For example, the filler may be included in the filled asphalt composition in an amount of from greater than 0 wt. % to about 70 wt. %, from greater than 0 wt. % to about 60 wt. %, from greater than 0 wt. % to about 50 wt. %, from greater than 0 wt. % to about 40 wt. %, from greater than 0 wt. % to about 30 wt. %, from about 10 wt. % to about 70 wt. %, from about 10 wt. % to about 60 wt. %, from about 10 wt. % to about 50 wt. %, from about 10 wt. % to about 40 wt. %, from about 10 wt. % to about 30 wt. %, from about 20 wt. % to about 70 wt. %, from about 20 wt. % to about 60 wt. %, from about 20 wt. % to about 50 wt. %, from about 20 wt. % to about 40 wt. %, from about 20 wt. % to about 30 wt. %, from about 30 wt. % to about 70 wt. %, from about 30 wt. % to about 60 wt. %, from about 30 wt. % to about 50 wt. %, from about 30 wt. % to about 40 wt. %, from about 40 wt. % to about 70 wt. %, from about 40 wt. % to about 60 wt. %, from about 40 wt. % to about 50 wt. %, from about 50 wt. % to about 70 wt. %, or from about 50 wt. % to about 60 wt. %, including all endpoints and subranges therebetween.

The filler material may include particles comprising any variety of ground inorganic particulate matter, such as, for example, ground limestone, dolomite or silica, talc, sand, cellulosic materials, fiberglass, calcium carbonate, clay, carbon, perlite, mica, fumed silica, carbon black, wollastonite, and combinations thereof. The filler material may comprise particles having an average (median) particle size in the range of 0.3 microns to 200 microns, including an average particle size range of 1 micron to 180 microns, 5 microns to 175 microns, 15 microns to 150 microns, 25 microns to 125 microns, 30 microns to 115 microns, 35 microns to 100 microns, 40 microns to 85 microns, and 45 microns to 60 microns, including all endpoints and subranges therebetween.

In various aspects, the additives that are incorporated into the asphalt coating composition are effective to modify one or more properties of the base asphalt. For example, the penetration value, the softening point, and/or the viscosity of the asphalt coating composition may be modified as compared to the base asphalt. In various aspects, an asphalt composition formed by blending the base asphalt, the phenolic lipid-based compatibilizer, and, optionally, the wax has a first penetration value. Upon introduction of the hardener into the asphalt composition, a second penetration value may be achieved, where the second penetration value is less than the first penetration value. Put another way, in aspects, the incorporation of the hardener may be effective to reduce the penetration value of the asphalt composition. In various aspects, the resultant asphalt composition to has a penetration value of no less than 15 dmm at 25° C. As used herein, the penetration value is measured according to ASTM D5.

Moreover, the asphalt composition may have a softening point of from about 88° C. to about 105° C. (190° F. to about 221° F.). For example, the softening point may be from about 88° C. to about 105° C., from about 88° C. to about 103° C., from about 88° C. to about 100° C., from about 88° C. to about 98° C., from about 88° C. to about 95° C., from about 90° C. to about 105° C., from about 90° C. to about 103° C., from about 90° C. to about 100° C., from about 90° C. to about 98° C., from about 90° C. to about 95° C., from about 93° C. to about 105° C., from about 93° C. to about 103° C., from about 93° C. to about 100° C., from about 93° C. to about 98° C., from about 93° C. to about 95° C., including all endpoints and subranges therebetween. In aspects, the asphalt composition may have a softening point of at least about 93° C. As used herein, the softening point is measured according to the Ring and Ball Softening Point Test described in ASTM D36.

In contrast to the asphalt compositions described herein, the base asphalt may have a lower softening point. For example, a paving grade base asphalt may have a softening point of from about 35° C. to about 55° C. A modified paving grade base asphalt may have a softening point of from about 50° C. to about 75° C., depending on the particular grade of base asphalt and the types of modifiers. Accordingly, in various aspects herein, the asphalt composition may have a softening point that is increased relative to the softening point of the base asphalt material.

Conventional processes are capable to handling material having a rotational viscosity of up to about 400 cP at a given temperature and oxidized asphalt coating compositions can have a viscosity up to 400 cP at 190° C. or 205° C. By contrast, polymer-modified asphalt coating compositions may exhibit a rotational viscosity of up to 850 cP at 176° C. However, the asphalt composition of any of the aspects described herein may have a rotational viscosity of less than about 400 cP when measured at 190° C. and in accordance with ASTM D4402. In aspects, the asphalt composition may have a rotational viscosity of less than about 400 cP when measured at 176° C. in accordance with ASTM D4402.

Accordingly, because the additives that are incorporated into the asphalt composition are effective to modify one or more properties of the base asphalt, the asphalt composition of various aspects may be suitable for use as a coating, such as a coating on a roofing material.

Moreover, although the asphalt composition of various aspects may exhibit various physical properties that are comparable to conventional oxidized coating compositions for roofing applications, the complex modulus of such compositions can differ. Complex modulus for filled asphalt coating compositions can be determined by collecting dynamic shear rheometer (DSR) frequency sweeps generally following the procedures set forth in ASTM D7175. In some aspects, DSR testing temperatures range from 0° C. to 110° C. at 10° C. intervals and oscillation strains below 2%, varying by temperature. An angular frequency sweep of 0.3-20 rad/s with multiple frequencies (e.g., 11 frequencies) spaced logarithmically are collected at each isotherm. Time-Temperature Superposition can be applied to create a universal mastercurve with a reference temperature of 25° C. using commercially available software, such as Rhea software (V2.4.0). When the log 10 of the complex modulus (in MPa) is plotted as a function of phase angle (in degrees; x-axis), the data points for the asphalt compositions according to various aspects have a higher correlation (R²) to a non-linear regression model than to a linear regression model.

### Roofing Materials

The asphalt composition disclosed herein be used as a coating on substrates for use in the manufacture of shingles and other roofing products, such as roofing underlayments, membranes, roll roofing, and the like. Asphalt-based roofing products are installed on roofs of buildings to provide protection from the elements and to give the roof an aesthetically pleasing look. In aspects in which the asphalt composition is a coating on a roofing material, the asphalt composition may be applied to at least a portion of a substrate. The substrate can be any type known for use in asphalt-based roofing materials, such as a web, scrim or felt of fibrous materials such as mineral fibers, fiberglass, cellulose fibers, rag fibers, mixtures of mineral and synthetic fibers, or the like. Combinations of materials can also be used in the substrate. In aspects, the substrate is a nonwoven web of glass fibers. The substrate may be any conventional substrate used in asphalt shingles, roll roofing, low-slope membranes, and the like.

A conventional roofing shingle is typically constructed of a substrate, an asphalt coating composition that saturates the substrate and forms a layer of asphalt coating on a top surface and a bottom surface of the substrate, a decorative/protective layer of granules applied to the asphalt coating on the top surface of the substrate, and optionally, a layer of sand or other parting agent applied to the asphalt coating on the bottom surface of the substrate. The asphalt coatings are generally formed from a layer of hot, melted asphalt composition applied to the substrate. The asphalt coating can be applied to the substrate in any suitable manner. For example, the substrate can be submerged in the asphalt composition or the asphalt composition can be rolled on, sprayed on, or applied to the substrate by other means.

The subject asphalt composition includes a synergistic combination of a hardener and a phenolic lipid-based compatibilizer that can be tuned to provide roofing coating specifications of softening point and penetration, while having a lower viscosity, which enables application at temperatures between about 120° C. and 176° C., thereby reducing energy and water consumption. Accordingly, in aspects, the asphalt composition described herein may enable energy savings (and carbon savings as a result of reduced energy), while employing reclaimed materials.

### EXAMPLES

### Example 1

In order to observe the impact of various resins on the penetration values of asphalt compositions, samples were prepared using various resins and at various concentrations. Sample A included only the base asphalt (MPC Detroit PG 64-22). Samples B-G included either 5 wt. % or 20 wt. % of a hardener having an acid value of less than 20 meq KOH. The formulations are provided in Table 1 below, along with the softening point, penetration values, and rotational viscosity values at 135° C., 149° C., and 163° C.

In Table 1, Resin 1 was a pine rosin ester having an acid value of 15 meq KOH or less. Resin 2 was a stabilized pentaerythritol ester of tall oil rosin having an acid number of 15 meq KOH or less. Resin 3 was a pentaerythritol ester tall oil resin having an acid value of 15 meq KOH or less.

TABLE 1

| | Sample A | | Sample B | | Sample C | | Sample D | | Sample E | | Sample F | | Sample G | |
|---|---|---|---|---|---|---|---|---|---|---|---|---|---|---|
| MPC Detroit PG 64-22 | 100 | wt. % | 95 | wt. % | 80 | wt. % | 95 | wt. % | 80 | wt. % | 95 | wt. % | 80 | wt. % |
| Resin 1 | — | | 5 | wt. % | 20 | wt. % | — | | — | | — | | — | |
| Resin 2 | — | | — | | — | | 5 | wt. % | 20 | wt. % | — | | — | |
| Resin 3 | — | | — | | — | | — | | — | | 5 | wt. % | 20 | wt. % |
| Softening Point | 48.9° | C. | 48.9° | C. | 53.9° | C. | 50.0° | C. | 53.9° | C. | 49.4° | C. | 55.0° | C. |
| Penetration (25° C.) | 60 | dmm | 54 | dmm | 30 | dmm | 51 | dmm | 28 | dmm | 52 | dmm | 28 | dmm |
| Rotational Viscosity (135° F.) | 439 | cP | 444 | cP | 443 | cP | 455 | cP | 518 | cP | 450 | cP | 475 | cP |
| Rotational Viscosity (149° F.) | 234 | cP | 232 | cP | 223 | cP | 244 | cP | 261 | cP | 244 | cP | 252 | cP |
| Rotational Viscosity (163° F.) | 133 | cP | 132 | cP | 127 | cP | 136 | cP | 147 | cP | 134 | cP | 131 | cP |

As shown in Table 1, the penetration values drop with the addition of the hardener. However, there is only a slight impact of the resin on the softening point of the asphalt composition, which remains below the desired minimum softening point of 88° C. for various applications. Based on this Example, it appears that additional modifications to the asphalt composition are needed to achieve the desired properties.

### Example 2

Next, to determine the impact of a phenolic lipid-based compatibilizer (cardanol) on the penetration values of asphalt compositions, a sample (Sample H) was prepared using 5 wt. % of the phenolic lipid-based compatibilizer and 95 wt. % base asphalt (PG 64-22) and compared to a sample (Sample I) including only the base asphalt. The formulations are provided in Table 2 below, along with the softening point, penetration values, and rotational viscosity values at 135° C., 149° C., and 163° C.

TABLE 2

| | Sample H | | Sample I | |
|---|---|---|---|---|
| PG 64-22 | 95 | wt. % | 100 | wt. % |
| Cardanol | 5 | wt. % | — | |
| Softening Point | 36° | C. | 47° | C. |
| Penetration (25° C.) | 249 | dmm | 68 | dmm |
| Rotational Viscosity (135° C.) | 197 | cP | 416 | cP |
| Rotational Viscosity (149° C.) | 111 | cP | 217 | cP |
| Rotational Viscosity (163° C.) | 67 | cP | 124 | cP |

As shown in Table 2, the penetration values increase significantly with the addition of a small amount of the phenolic lipid-based compatibilizer, while the softening point decreases. The softening point of the asphalt composition remains below the desired minimum softening point of 88° C. for various applications. The phenolic lipid-based compatibilizer also causes a significant decrease in the viscosity of the asphalt composition.

### Example 3

Next, three comparative compositions (Samples J, L, and M) and one exemplary composition (Sample K) were prepared. Each of these four compositions included a base asphalt (MPC Detroit PG 64-22) and reclaimed asphalt (extracted asphalt from RAS). Samples J-L included wax. Sample L included a hardener (pine resin), Sample M included a phenolic lipid-based compatibilizer (cashew nut shell oil blend), and Sample K included both the hardener and the phenolic lipid-based compatibilizer. The compositions are provided in Table 3 below, in which the contents are reported in weight percent (wt. %) based on the total solids content of the asphalt composition. The softening point, penetration, and rotational viscosity (at 190° C., 176° C., and 204° C.) for each composition are also reported in Table 3.

TABLE 3

| | Sample J | | Sample K | | Sample L | | Sample M | |
|---|---|---|---|---|---|---|---|---|
| MPC Detroit PG 64-22 | 39 | wt. % | 37 | wt. % | 39 | wt. % | 41 | wt. % |
| Extracted asphalt from RAS | 53 | wt. % | 50 | wt. % | 52 | wt. % | 55 | wt. % |
| Cashew Oil Blend | 4 | wt. % | 4 | wt. % | — | | 4 | wt. % |
| Pine Resin | — | | 5 | wt. % | 5 | wt. % | — | |
| Wax | 4 | wt. % | 4 | wt. % | 4 | wt. % | — | |
| Softening Point | 93° | C. | 90° | C. | 98.8° | C. | 80.5° | C. |
| Penetration (25° C.) | 23 | dmm | 20 | dmm | 11 | dmm | 23 | dmm |
| Rotational Viscosity (176° C.) | 402 | cP | 295 | cP | 633 | cP | 537 | cP |
| Rotational Viscosity (190° C.) | 225 | cP | 173 | cP | 337 | cP | 297 | cP |
| Rotational Viscosity (204° C.) | 130 | cP | 108 | cP | 194 | cP | 183 | cP |

As shown in Table 3, adding the wax while decreasing the amount of reclaimed asphalt (Sample J) increased the softening point but lowered the rotational viscosity as compared to Sample M. By comparing Sample M (including reclaimed asphalt) with Sample H above (not including reclaimed asphalt), the combination of the reclaimed asphalt with the phenolic lipid-based compatibilizer can provide a significant increase in the softening point while maintaining a penetration value within specification for roofing coating applications. However, the softening point was still out of specification for the roofing coating applications.

Replacement of the phenolic lipid-based compatibilizer with the hardener (Sample L) increased the softening point and viscosity (as compared to Sample J) but decreased the penetration value to a level that rendered the composition unsuitable for use in roofing applications.

However, the addition of the hardener (e.g., pine resin) along with the phenolic lipid-based compatibilizer and wax in Sample K decreased the penetration without substantially increasing the softening point or the viscosity as compared to Sample J. Importantly, the inclusion of the hardener brought the penetration value of Sample K into specification for roofing coating applications while maintaining the lower softening point and viscosity.

### Example 4

To further explore the impact of the amounts of the phenolic lipid-based compatibilizer and hardener, four comparative compositions (Samples N-Q) and two exemplary compositions (Samples R-S) were prepared. The formulations are provided in Table 4 below. For each of the formulations, the PMA included paving grade asphalt modified with 5-7 wt. % polymer and 1-3 wt. % wax. The softening point, penetration, and rotational viscosity (at 176° C.) for each composition are also reported in Table 4.

TABLE 4

| | Sample N | | Sample O | | Sample P | | Sample Q | | Sample R | | Sample S | |
|---|---|---|---|---|---|---|---|---|---|---|---|---|
| PMA | 100 | wt. % | 98 | wt. % | 96 | wt. % | 94 | wt. % | 95 | wt. % | 93 | wt. % |
| Cashew Oil Blend | — | | — | | — | | — | | 1 | wt. % | 1 | wt. % |
| Pine Resin | — | | 2 | wt. % | 4 | wt. % | 6 | wt. % | 4 | wt. % | 6 | wt. % |
| Softening Point | 97.8° | C. | 106° | C. | 95.6° | C. | 91.7° | C. | 97.2° | C. | 96.7° | C. |
| Penetration (25° C.) | 37 | dmm | 32 | dmm | 28 | dmm | 30 | dmm | 25 | dmm | 21 | dmm |
| Rotational Viscosity (176° C.) | 485 | cP | 500 | cP | 508 | cP | 465 | cP | 538 | cP | 460 | cP |

As shown in Table 4, the inclusion of the hardener alone (Samples O-Q) were effective to decrease the penetration of the asphalt composition as compared to the control (Sample N). However, an increasing amount of hardener did not correspond with a decreasing penetration, as shown by comparing the penetration values of Samples P and Q. Moreover, Table 4 shows that amounts of hardener of 4 wt. % and 6 wt. % were effective to decrease the softening point.

Looking at Samples R and S, the inclusion of the phenolic lipid-based compatibilizer and the hardener enable a decreased penetration while maintaining a relatively constant softening point, as compared to the control (Sample N). By comparing the values of Sample R with the values of Sample P, the addition of 1 wt. % of the phenolic lipid-based compatibilizer raised the softening point to roughly the softening point of control Sample N, while further decreasing the penetration. Similarly, by comparing the values of Sample S with the values of Sample Q, the addition of 1 wt. % of the phenolic lipid-based compatibilizer raised the softening point to roughly the softening point of control Sample N, while further decreasing the penetration. Accordingly, the combination of the phenolic lipid-based compatibilizer and the hardener enable properties of the asphalt composition, such as softening point and penetration, to be effectively “tuned” by balancing the relative amounts of each in the asphalt composition.

### Example 5

The rheology of various asphalt compositions was also explored. Two exemplary compositions (Sample T and Sample U) and one comparative composition (Sample V) were prepared. Sample V was 100% oxidized asphalt. The formulations are provided in Table 5 below.

TABLE 5

| | Sample T | | Sample U | | Sample V | |
|---|---|---|---|---|---|---|
| Oxidized Asphalt | — | | — | | 100 | wt. % |
| PG 64-22 | 33 | wt. % | 28 | wt. % | — | |
| Extracted asphalt from RAS | 46 | wt. % | 60 | wt. % | — | |
| Pine Resin | 4 | wt. % | 4 | wt. % | — | |
| Cashew oil blend | 4 | wt. % | 4 | wt. % | — | |
| Wax | 5 | wt. % | 5 | wt. % | — | |
| Ground Tire Rubber (GTR) | 8 | wt. % | — | | — | |
| Softening Point | 98° | C. | 96° | C. | 99° | C. |
| Penetration (25° C.) | 16 | dmm | 14.5 | dmm | 16.9 | dmm |
| Rotational Viscosity (177° C.) | 1110 | cP | 815 | cP | 1175 | cP |
| Rotational Viscosity (204° C.) | 328 | cP | 215 | cP | 300 | cP |

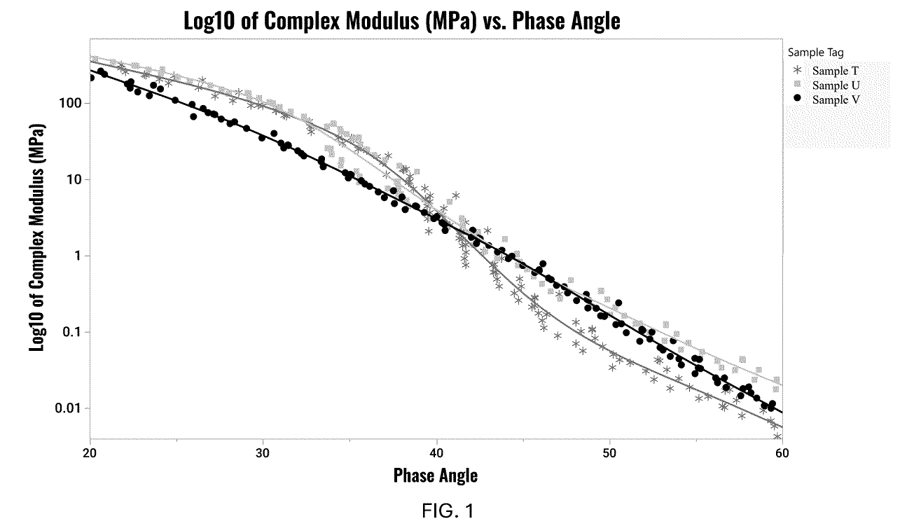

As shown in Table 5, the physical values of softening point, penetration, and rotational viscosity of the exemplary compositions are comparable to those of the oxidized asphalt composition. Each of the compositions in Table 5 was then mixed with 65 wt. % calcium carbonate filler to provide filled asphalt compositions. In order to identify physical property differences between the filled oxidized asphalt composition and the filled exemplary compositions, dynamic shear rheometer (DSR) frequency sweeps were collected on an HR10 from Discovery Hybrid Rheometer series by TA Instruments with 8 mm parallel plates geometry, generally following the procedures set forth in ASTM D7175. DSR testing temperatures ranges from 0° C. to 110° C. at 10° C. intervals and oscillation strains below 2%, varying by temperature. An angular frequency sweep of 0.3-20 rad/s with eleven frequencies spaced logarithmically was collected at each isotherm. Time-Temperature Superposition was then applied to create a universal mastercurve with a reference temperature of 25° C. using Rhea software (V2.4.0). The results are shown in FIG. 1 as a graph of the log 10 of the complex modulus (in MPa; y-axis) as a function of phase angle (in degrees; x-axis). This data representation is known as Black Space diagram and is a common way of evaluating asphalt binder.

As shown in FIG. 1, the filled exemplary compositions (Samples T and U) deviate from a linear regression fit while the filled oxidized asphalt composition (Sample V) fits a linear regression with a R² of 0.99. Put another way, the data points for the exemplary compositions have a higher correlation (R²) to a non-linear regression model than to a linear regression model. The complex modulus of the exemplary compositions was greater at any phase angle below 40 degrees than the complex modulus of the oxidized asphalt. A phase angle of 27 degrees is a good point of comparison, showing that the exemplary compositions with higher modulus will offer higher dissipation than the oxidized asphalt composition when used in similar roofing applications. The exemplary compositions may further offer higher potential impact resistance and improved aging properties.

To the extent not already described, the different features and structures of the various embodiments of the present disclosure may be used in combination with each other as desired. For example, one or more of the features illustrated and/or described with respect to one aspect of the disclosure can be used with or combined with one or more features illustrated and/or described with respect to other aspects of the disclosure. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described.

While aspects of the present disclosure have been specifically described in connection with certain specific embodiments thereof, it is to be understood that this is by way of illustration and not of limitation. Reasonable variation and modification are possible within the scope of the forgoing disclosure without departing from the spirit of the present disclosure which is defined in the appended claims.

What is claimed is:

1. An asphalt composition comprising:
about 10 wt. % to about 80 wt. % of a base asphalt;
about 1 wt. % to about 40 wt. % of a hardener having an acid value of less than 30 meq KOH;
about 1 wt. % to about 20 wt. % of a phenolic lipid-based compatibilizer; and
0 wt. % to about 10 wt. % of a wax, wherein the asphalt composition has a penetration value at 25° C. of no less than 15 dmm and a softening point of at least 93° C.

2. The asphalt composition of claim 1, wherein the phenolic lipid-based compatibilizer is free of carboxyl groups, carbonyl groups, and derivatives thereof.

3. The asphalt composition of claim 1, wherein the phenolic lipid-based compatibilizer comprises a phenolic liquid.

4. The asphalt composition of claim 1, wherein the phenolic lipid-based compatibilizer comprises a cashew nut shell liquid, cashew nut shell distillate, cardol, cardanol, or mixtures thereof.

5. The asphalt composition of claim 1, wherein the base asphalt comprises paving grade asphalt, oxidized asphalt, non-oxidized asphalt, polymer-modified asphalt, or mixtures thereof.

6. The asphalt composition of claim 1, wherein the base asphalt is a polymer modified asphalt and the asphalt composition further comprises up to 15 wt. % of a polymer additive comprising one or more of reclaimed rubber, natural rubber, ground tire rubber (GTR), devulcanized ground tire rubber, styrene-butadiene block copolymer (SBS), chloroprene rubber (CR), amorphous polyolefin, latex, butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated SBS, vinylacetate/polyethylene (EVA), and mixtures thereof.

7. The asphalt composition of claim 1, wherein the hardener is selected from the group consisting of a modified pine resin, a modified pine rosin, a tall pitch oil, and mixtures thereof.

8. The asphalt composition of claim 1, wherein the asphalt composition is a coating on a roofing material.

9. A filled asphalt composition comprising the asphalt composition of claim 1 and a filler.

10. A roofing shingle comprising the filled asphalt composition of claim 9.

11. A roofing underlayment comprising the filled asphalt composition of claim 9.

12. A roofing material comprising:
a substrate; and
the asphalt coating composition of claim 1 applied to at least a portion of the substrate.

13. An asphalt composition comprising:
about 10 wt. % to about 60 wt. % of a base asphalt;
20 wt. % to about 70 wt. % of recycled or reclaimed asphalt material having a penetration value at 25° C. of from 0 dmm to 10 dmm;
about 1 wt. % to about 40 wt. % of a hardener having an acid value of less than 30 meq KOH;
about 1 wt. % to about 15 wt. % of a phenolic lipid-based compatibilizer; and
0 to about 10 wt. % of a wax, wherein the asphalt composition has a viscosity at 204° C. of less than 400 cP.

14. The asphalt composition of claim 12, wherein the reclaimed asphalt material comprises greater than 50% asphalt content.

15. The asphalt composition of claim 12, wherein the reclaimed asphalt material comprises greater than 75% asphalt content.

16. A filled asphalt composition comprising the asphalt composition of claim 12 and a filler.

17. A roofing shingle comprising the filled asphalt composition of claim 15.

18. A roofing underlayment comprising the filled asphalt composition of claim 15.

19. A roofing material comprising:
a substrate; and
the asphalt coating composition of claim 13 applied to at least a portion of the substrate.

20. A method of modifying the hardness of an asphalt coating composition, the method comprising:
forming an asphalt composition having a first penetration value by blending:
about 10 wt. % to about 80 wt. % of a base asphalt;
about 1 wt. % to about 20 wt. % of a phenolic lipid-based compatibilizer; and
0 to about 10 wt. % of a wax, and
introducing about 1 wt. % to about 40 wt. % of a hardener into the asphalt composition to achieve a second penetration value, wherein the second penetration value is less than the first penetration value.
